(19) United States
(12) Patent Application Publication
(10) Pub. No.: US 2025/0277103 A1
(43) Pub. Date: Sep. 4, 2025

(54) AN AQUEOUS ANTIOXIDANT SUSPOEMULSION AND A PROCESS FOR PREPARING THE SAME

(71) Applicant: BASF SE, Ludwigshafen am Rhein (DE)

(72) Inventors: Michael ISHAQUE, Shanghai (CN); Yi Qiong ZHOU, Shanghai (CN); Gang TENG, Shanghai (CN)

(21) Appl. No.: 18/857,478

(22) PCT Filed: Apr. 17, 2023
(86) PCT No.: PCT/EP2023/059886

§ 371 Date: Oct. 17, 2024

(30) Foreign Application Priority Data
Apr. 20, 2022 (WO) PCT/CN2022/087934

(51) Int. Cl. C08K 5/134; C08K 5/105; C08K 5/13; C08K 5/37; C08K 5/375; C08K 5/378

(52) U.S. Cl. CPC C08K 5/1345; C08K 5/105; C08K 5/13; C08K 5/37; C08K 5/375; C08K 5/378

(57) ABSTRACT

Present disclosure relates to an aqueous antioxidant suspoemulsion, comprising at least one solid antioxidant present as particles in a continuous water phase and at least one liquid antioxidant present as droplets in a dispersed oil phase. Present disclosure also relates to a process for preparing the aqueous antioxidant suspoemulsion, and a polymer composition containing the aqueous antioxidant suspoemulsion.

### TECHNICAL FIELD

Present disclosure relates to an aqueous antioxidant suspoemulsion, a process for preparing the aqueous antioxidant suspoemulsion, and a polymer composition containing the aqueous antioxidant suspoemulsion.

### BACKGROUND

Polymers like plastic, rubber and resin tends to be oxidized and degraded from production and application to service life. Accordingly, appearance and physical mechanical performance of the polymeric materials are prone to deterioration. For example, the ABS (acrylonitrile butadiene styrene) resin is a terpolymer consisting of acrylonitrile, butadiene and styrene. Because of its excellent impact resistance, chemical resistance and processability, ABS resin has been widely used in various fields. However, ABS resin has poor weather (light/heat) resistance partly because the butadiene molecular chain contained therein. So, ABS resin is easily oxidized and thereby gradually turns yellow, becomes hard and brittle when it is exposed to heat, light and/or oxygen in the environment.

Besides, ABS resin is generally produced by emulsion polymerization. In the preparation process, the obtained ABS latex will be subjected to coagulation, dehydration and drying treatments. And the drying process is generally carried out at 110-130° C. Under such high temperature condition, ABS powder will be more easily susceptible to oxidation.

The addition of antioxidant is a typical solution to prevent and mitigate above issues. When polymers are produced by suspension/micro-suspension/emulsion polymerization, it is particularly desired to have an antioxidant composition in dispersion form which is easy to operate as well as with good antioxidant performance.

Besides, it is desired in the art to have an antioxidant combination comprising at least two different antioxidants in order to achieve synergistic effect in terms of anti-oxidation. However, commercially available antioxidant combinations are mainly limited to two or more solid antioxidants in suspension form, or two or more liquid antioxidants in emulsion form. It is desired to extend the scope of suitable antioxidant combinations in dispersion form, particular to provide a combination of solid antioxidant and liquid antioxidant.

Several attempts have been made to achieve this target. For example, CN 110627929A disclosed a process for preparing nano grade aqueous antioxidant emulsion for stabilizing polymers with solid antioxidant by melt emulsification and homogenization. CN10218072B disclosed a process for preparing an aqueous antioxidant emulsion with solid and liquid antioxidants by a melt emulsification process. During the preparation process of both CN 110627929A and CN10218072B, solid antioxidant is firstly melted at high temperature and then emulsified using emulsifiers. However, since the reaction vessel need to retain high temperature (i.e. above melting point of solid antioxidant) in main production steps in order to keep the solid antioxidant in melting status, production cost for these methods is high and antioxidant performance may be deteriorated due to high temperature treatment.

### SUMMARY

In view of above drawbacks, present disclosure aims to provide a new antioxidant dispersion prepared by combining an antioxidant emulsion and an antioxidant suspension, which can be easily added thereafter to suspension/micro-suspension/emulsion polymerization of polymers, which is economically viable, and confers thermal stability, as well as good anti-oxidation and anti-aging performance to the final polymer product.

In a first aspect, present disclosure provides an aqueous antioxidant suspoemulsion, comprising
(i) a continuous water phase of component (C1), comprising
   (a) at least one solid antioxidant having a melting point of above 20° C.,
   (b) a first surfactant; and
   (c) water having the solid antioxidant suspended therein;
And
(ii) a dispersed oil phase of component (C2), comprising
   (d) at least one liquid antioxidant having a melting point of below 20° C., and
   (e) a second surfactant having the liquid antioxidant dispersed in the water; the solid antioxidant is present in a form of particles with median particle size D50 of below 10 μm, and the liquid antioxidant is present in a form of droplets with median particle size D50 of below 10 μm.

The aqueous antioxidant suspoemulsion provided in the first aspect of present disclosure contains solid antioxidant present as particles in continuous water phase and liquid antioxidant present as droplets in dispersed oil phase in one formulation, which greatly broadens the scope of suitable antioxidants blends. Particularly, the solid antioxidant particles and the liquid antioxidant droplets are independent/separate from each other in the continuous water phase.

Besides, the aqueous antioxidant suspoemulsion of present disclosure is thermally stable and also shows excellent antioxidant performance for protecting polymeric materials against oxidation caused by high temperature and etc., and thereby extends product life cycle.

In a second aspect, present disclosure provides a process for preparing the aqueous antioxidant suspoemulsion, comprising below steps:
Step 1. Preparing a suspension of a solid antioxidant by mixing at least one solid antioxidant having a melting point of above 20° C., a first surfactant with water;
Step 2. Preparing an oil-in-water emulsion of a second antioxidant by mixing at least one liquid antioxidant having a melting point of below 20° C., a second surfactant with water; and
Step 3. Preparing an aqueous antioxidant suspoemulsion by adding the oil-in-water emulsion prepared in step 2 into the suspension prepared in step 1 under continuous agitation;
Homogenizing the solid antioxidant and the liquid antioxidant until median particle size D50 of solid antioxidant and liquid antioxidant being below 10 μm is achieved.

Alternatively, the aqueous antioxidant suspoemulsion of present disclosure can also be prepared by following steps:
Step 1. Preparing a suspension of a solid antioxidant by mixing at least one solid antioxidant having a melting point of above 20° C., a first surfactant with water;
Step 2. Preparing a self emulsifiable concentrate of a liquid antioxidant by mixing at least one liquid antioxidant having a melting point of below 20° C. with a second surfactant; and
Step 3. Preparing an aqueous antioxidant suspoemulsion by adding the self emulsifiable concentrate prepared in step 2 into the suspension prepared in step 1 under continuous agitation;
Homogenizing the solid antioxidant and the liquid antioxidant until median particle size D50 of solid antioxidant and liquid antioxidant being below 10 μm is achieved.

Compared to prior art, solid antioxidant does not need to be melted according to present process. It was found by present inventors that a stable aqueous antioxidant suspoemulsion can be obtained when particle size of the solid/liquid antioxidant is reduced to below 10 μm which can be achieved by homogenization (e.g. by homogenizer). Therefore, present process does not require melting (high temperature) treatment of the solid antioxidants which makes present process being simpler and more cost effective.

Besides, antioxidant performance of the solid antioxidant is better preserved without undergoing high temperature treatment.

In a third aspect, present disclosure also provides an aqueous antioxidant suspoemulsion prepared according to the process as described in the second aspect of present disclosure.

In a fourth aspect, present disclosure provides use of the aqueous antioxidant suspoemulsion in stabilizing polymeric materials.

In a fifth aspect, present disclosure provides a polymer composition, comprising a polymer or copolymer in a form of aqueous suspension or emulsion; and an aqueous antioxidant suspoemulsion according to present disclosure.

### DETAILED DESCRIPTION

In below description, further explanations to present disclosure are made with reference to embodiments so as to facilitate sufficient understanding for skilled person in the art. It should be understood that these embodiments are provided merely for better understanding the subject matter of present disclosure, not for making any limitations to the protection scope, applicability or embodiments as described in present claims set. It should be understood that skilled person in the art can omit, replace, or add various technical features to each embodiment based on actual needs, subject to the premise of without departing from the spirit of present disclosure. In addition, technical features described in some embodiments can be combined with technical features described in other embodiments.

Unless defined otherwise, all technical and scientific terms used herein have the same meanings as commonly understood by skilled person in the art to which present disclosure belongs.

In present disclosure, terms “comprise”, “comprising” and various variants thereof can be understood as open ended terms, which means “include but are not limited to”; in contrast, the term “consisting of” and various variants thereof excludes any component, step or procedure not specifically listed; the term “one embodiment” can be understood as “at least one embodiment”; the term “another embodiment” may be understood as “at least one other embodiment.” Other terms that may appear but are not mentioned here, unless explicitly stated, should not be interpreted or limited in a manner that is contrary to the concept on which the embodiments of present disclosure are based.

Throughout present disclosure, expressions like “a”, “an”, “the” and “one or more” are used inter-changeably and are intended to include both the plural and the singular except in cases where the singular alone is explicitly specified or is clearly indicated by the context. When the singular alone is intended for, the term “one” is typically used. The term “or” is generally intended to include the sense of “and/or” unless the content clearly dictates otherwise. “Preferred”, “preferable” and “preferably” as used herein interchangeably refer to embodiments of present disclosure that may bring certain advantages under certain situations. However, other embodiments may also be preferred, under the same situations. Further, the recitation of one or more preferred embodiments does not mean that other embodiments are not suitable and is not intended to exclude other embodiments from the scope of present disclosure.

All percentages, parts and ratios are by weight, unless otherwise specified. And the recitation of numerical ranges by end values includes all numbers subsumed within that range (e.g., from 5 to 10 includes 5, 5.1, 5.2, 5.55, 6, 6.5, 7, 7.5, 8, 8.5, 9, 9.5, . . . 10).

Throughout present disclosure, expressions of temperature refers to the value measured under 101.325 Kpa.

The term “suspoemulsion” (SE) is a mixture/combination of suspension containing solid active ingredient and emulsion containing liquid active ingredient. The term “aqueous antioxidant suspoemulsion” refers to solid antioxidant which is dispersed in a continuous phase as particles, and liquid antioxidant which is dispersed in a continuous phase as oil droplets, and water, which is used as the continuous phase carrying both solid antioxidant and liquid antioxidant. In specific, oil droplets containing the liquid antioxidant and particles of the solid antioxidant are uniformly distributed in the aqueous continuous phase. Particularly, the solid antioxidant particles and the liquid antioxidant droplets are independent/separate from each other in the continuous water phase. The aqueous antioxidant suspoemulsion of present disclosure can protect polymer products against oxidation caused by UV light, high temperature and etc.

The term “dispersed oil phase” refers to a phase containing liquid organic component(s), i.e. at least one liquid antioxidant. The liquid antioxidant(s) is immiscible/unbendable with water.

The term “particle size” refers to the diameter of particles formed by solid ingredients or diameter of oil droplets formed by liquid ingredients which are dispersed in the continuous phase. Typical particle/droplet size parameters include D10, D50, D90. The term “median particle size” refers to D50 value where 50% by volume of the particles/droplets have diameters that are smaller or equivalent to the D50 value. Particle/droplet size can be measured by conventional particle size analyzers that are commonly used in the art.

The term “polymer” or “polymers”, as used herein, includes both homopolymer(s), that is, polymers prepared from a single reactive compound, and copolymer(s), that is, polymers prepared by reaction of at least two polymer forming reactive, monomeric compounds.

### I. Aqueous Antioxidant Suspoemulsion

In view of existing problems in the prevention against oxidation for polymers, in a first aspect, present disclosure provides an aqueous antioxidant suspoemulsion, comprising
(i) a continuous water phase of component (C1), comprising
   (a) at least one solid antioxidant having a melting point of above 20° C.;
   (b) a first surfactant; and
   (c) water having the solid antioxidant suspended therein;
And
(ii) a dispersed oil phase of component (C2), comprising
   (d) at least one liquid antioxidant having a melting point of below 20° C., and
   (e) a second surfactant having the liquid antioxidant dispersed in the water;
the solid antioxidant is present in a form of particles with median particle size D50 of below 10 μm, and the liquid antioxidant is present in a form of droplets with median particle size D50 of below 10 μm.

The aqueous antioxidant suspoemulsion of present disclosure contains solid antioxidant present as particles in continuous water phase and liquid antioxidant present as droplets in dispersed oil phase in one formulation. Therefore, present disclosure provides a new system, i.e. an antioxidant combination in aqueous suspoemulsion form, which is suitable for stabilizing polymeric materials synthesized by suspension/micro-suspension/emulsion polymerization and greatly broadens the scope of suitable antioxidants blends.

Besides, present aqueous antioxidant suspoemulsion has no upper limitation on the melting point of suitable solid antioxidants as long as their melting point exceeds 20° C. and thereby being solid at 20° C.

Meanwhile, the aqueous antioxidant suspoemulsion of present disclosure is thermally stable owing to that the median particle size of the solid antioxidant and liquid antioxidant is below 10 μm. Neither observable creaming nor sedimentation occurs during the storage period.

Aqueous antioxidant suspoemulsion of present disclosure also shows excellent antioxidant performance for protecting polymeric materials against oxidation caused by high temperature, oxygen and etc., and thereby extends product life cycle. In some embodiments, aqueous antioxidant suspoemulsion of present disclosure also shows strong synergistic effect in terms of thermal stabilization and anti-oxidation indicated by the significantly increased OIT Peak time.

### Solid Antioxidant(s)

Types of suitable solid antioxidant is not particularly limited in present disclosure as long as its melting point is above 20° C. Examples include but are not limited to hindered phenolic, thioester, thioether, amines, hydroxylamines, lactones, lactone-phosphites or lactone-phosphates in solid form. Skilled artisan may choose one or more suitable solid antioxidant(s) per specific application.

The solid antioxidant suitable for present disclosure has a melting point of above 20° C., for example, above 25° C., 30° C., 35° C., 40° C., 50° C., 60° C., 70° C., 80° C., 90° C. or above 100° C., so that the solid antioxidant is present in a form of solid at 20° C. which is the typical room temperature for preparing the antioxidant composition. Antioxidants having a melting point of above 25° C., particularly above 30° C. are more preferred.

Examples of suitable solid antioxidant(s) include octadecyl 3-(3,5-di-tert-butyl-4-hydroxyphenyl) propionate (e.g. Irganox® 1076), 3,3′-Thiodipropionic acid dioctadecylester (e.g. Irganox® PS 802), pentaerythritol tetrakis[β-(3,5,-di-tert-butyl-4-hydroxyphenyl) propionate] (e.g. Irganox® 1010), 2,6-di-tert-butyl-4-(4,6-bis(octylthio)-1,3,5-triazin-2-ylamino) phenol (e.g. Irganox® 565), 3,3′,3′,5,5′,5′-hexa-tert-butyl-a, a′, a′-(mesitylene-2,4,6-triyl) tri-p-cresol (e.g. Irganox® 1330), Phenol, 4-methyl-, reaction products with dicyclopentadiene and isobutylene (e.g. Wingstay® L), ethylenebis(oxyethylene)bis[3-(5-tert-butyl-4-hydroxy-m-tolyl) propionate] (e.g. Irganox® 245), 1,3,5-tris(3,5-di-tert-butyl-4-hydroxybenzyl)-1,3,5-triazine-2,4,6 (1H,3H,5H)trione (e.g. Irganox® 3114), Thiodiethylene bis[3-(3,5-di-tert-butyl-4-hydroxyphenyl) propionate] (e.g. Irganox® 1035), N,N′-hexane-1,6-diylbis(3-3,5-di-tert-butyl-4-hydroxyphenylpropionamide) (e.g. Irganox® 1098), N,N′-Bis(3,5-di-butyl-4-hydroxyle-phenyl propionyl) hydrazine (e.g. Irganox® MD 1024), 1,3,5-tris[(4-tert-butyl-3-hydroxy-2,6-dimethylphenyl)methyl]-1,3,5-triazinane-2,4,6-trione (e.g. Cyanox® 1790), 2,2′-Methylenebis(4-methyl-6-tert-butylphenol); Hexamethylene bis[3-(3,5-di-tert-butyl-4-hydroxyphenyl) propionate] (e.g. Irganox® 259), Butylated hydroxytoluene (abbreviated as BHT), 2-(1,1-dimethylethyl)-6-[[3-(1,1-dimethylethyl)-2-hydroxy-5-methylphenylymethyl-4-methylphenyl acrylate (e.g. Irganox® 3052), 2,2-Bis[3-(dodecylthio)-1-oxopropoxy]methyl]propane-1,3-diyl bis[3-(dodecylthio) propionate] (e.g. Seenox® 412s), 2,4-Bis(dodecylthiomethyl)-6-methylphenol (e.g. Irganox® 1726), Didodecyl-3,3′-thiodipropionate (e.g. Irganox® PS 800), and combinations thereof.

Examples of suitable lactones in solid form include but are not limited to those described in WO8001566, U.S. Pat. Nos. 5,516,920, 4,325,863, 4,488,117, 8,653,284, US20210171747 and U.S. Pat. No. 8,840,810 which are incorporated here in their entirety. Examples of lactone-phosphites, lactone-phosphates or their analogous include but are not limited to those described in WO15121445 and WO17025431 which are incorporated here in their entirety.

In some preferable embodiments, the solid antioxidant is selected from the group consisting of 3,3′-Thiodipropionic acid dioctadecylester (e.g. Irganox® PS 802), 3,3′,3′, 5,5′,5′-hexa-tert-butyl-a,a′, a′-(mesitylene-2,4,6-triyl) tri-p-cresol (e.g. Irganox® 1330), 2,6-di-tert-butyl-4-(4,6-bis(octylthio)-1,3,5-triazin-2-ylamino) phenol (e.g. Irganox® 565), Phenol, 4-methyl-, reaction products with dicyclopentadiene and isobutylene (e.g. Wingstay® L), ethylenebis(oxyethylene)bis[3-(5-tert-butyl-4-hydroxy-m-tolyl) propionate] (e.g. Irganox® 245), 1,3,5-tris[(4-tert-butyl-3-hydroxy-2,6-dimethylphenyl)methyl]-1,3,5-triazinane-2,4,6-trione (e.g. Cyanox® 1790), 2,2-Bis[[3-(dodecylthio)-1-oxopropoxy]methyl]propane-1,3-diyl bis[3-(dodecylthio) propionate] (e.g. Seenox® 412s), 2,4-Bis(dodecylthiomethyl)-6-methylphenol (e.g. Irganox® 1726), and combinations thereof. These solid antioxidants have better thermal stability.

The solid antioxidant is present as particles with median particle size D50 of below 10 μm, preferably below 5 μm, more preferably below 2 μm. The smaller the particle size of the solid antioxidant particles, the more stable the aqueous antioxidant suspoemulsion. When the median particle size D50 is bigger than 10 μm, the risk of occurring coagulation is high. The method for achieving above median particle size D50 is well known in the art. Detailed description of applicable methods and equipment will be described in below second aspect (II. Process for preparing the aqueous antioxidant suspoemulsion).

### Liquid Antioxidant(s)

Types of suitable liquid antioxidants are not particularly limited in present disclosure as long as its melting point is below 20° C. Examples include but are not limited to hindered phenolic, thioester, thioether, amines, hydroxylamines, or lactones in liquid form. Skilled artisan may choose one or more suitable liquid antioxidant(s) per specific application.

The liquid antioxidant suitable for present disclosure has a melting point of below 20° C., for example, below 15° C., 10° C., or below 5° C., so that the liquid antioxidant is present in a form of liquid at 20° C. which is the typical room temperature for preparing the antioxidant composition. Antioxidants having a melting point of below 15° C., particularly below 10° C. is more preferred.

Examples of suitable liquid antioxidant include 4,6-bis(octylthiomethyl)-o-cresol (e.g. Irganox® 1520 L); 2,4-dimethyl-6-(1-methyl pentadecyl) phenol (cas: 134701-20-5, e.g. Irganox® 145); benzenepropanoic acid, 3,5-bis(1,1-dimethyl-ethyl)-4-hydroxy-C7-C9 branched alkyl esters (e.g. Irganox® 1135); Benzenamine, N-phenyl-, reaction products with 2,4,4-trimethylpentene (e.g. Irganox® 5057); ditridecyl 3,3′-thiodipropionate (e.g. Songnox® DTDTDP); benzenepropanoic acid, 3,5-bis(1,1-dimethylethyl)-4-hydroxy-, C13-15-branched and linear alkyl esters (e.g. Anox® 1315); Bis[2-methyl-4-{3-n-alkyl (C12 or C14) thiopropionyloxy}-5-tert-butylphenyl] sulfide (e.g. ADK Stab® AO 23); Thiobis-[2-tert-butyl-5-methyl-4, 1-phenylene]bis[3-(dodecylthio) propionate] (e.g. ADK Stab® AO 26); and combinations thereof.

Examples of suitable lactones in liquid form include but are not limited to those described in WO8001566, U.S. Pat. Nos. 5,516,920, 4,325,863, 4,488,117, 8,653,284, US20210171747 and U.S. Pat. No. 8,840,810 which are incorporated here in their entirety.

In some preferable embodiments, the liquid antioxidant is selected from the group consisting of 4,6-bis(octylthiomethyl)-o-cresol (e.g. Irganox® 1520 L); benzenepropanoic acid, 3,5-bis(1,1-dimethyl-ethyl)-4-hydroxy-C7-C9 branched alkyl esters; benzenamine, N-phenyl-, reaction products with 2,4,4-trimethylpentene (e.g. Irganox® 5057), ditridecyl 3,3′-thiodipropionate (e.g. Songnox® DTDTDP), benzenepropanoic acid, 3,5-bis(1,1-dimethylethyl)-4-hydroxy-, C13-15-branched and linear alkyl esters (e.g. Anox® 1315), and combinations thereof. These liquid antioxidants have better thermal stability and they are more active in terms of antioxidation.

In some preferable embodiments, the liquid antioxidant is present as droplets with median particle size D50 of below 10 μm, preferably below 5 μm, more preferably below 2 μm. The smaller the droplet size of the liquid antioxidant droplets, the more stable the aqueous antioxidant suspoemulsion. The method for achieving above median particle size D50 is well known in the art. Detailed description of applicable methods and equipment will be described in below second aspect.

In some preferable embodiments, the solid antioxidant together with the liquid antioxidant is present in an amount of at least 20 wt %, preferably at least 30 wt %, based on total weight of the aqueous antioxidant suspoemulsion. The solid antioxidant and liquid antioxidant can be present in the formulation in any weight ratio. For example, the weight ratio of the solid antioxidant to the liquid antioxidant is in the range from 1:50 to 50:1, 1:40 to 40:1, 1:30 to 30:1, 1:20 to 20:1, 1:10 to 10:1, 1:5 to 5:1.

In some preferable embodiments, in present aqueous antioxidant suspoemulsion, the solid antioxidant is a half-hindered phenol and the liquid antioxidant is a thiosynergist. Compared to fully hindered phenol, half hindered phenol is more preferable as it shows less steric hindrance which makes it being more active in terms of anti-oxidation performance. Examples of half-hindered phenols are already known in the art. For example, Irganox® 245 (Chemical name: Ethylene bis(oxyethylene)bis-(3-(5-tert-butyl-4-hydroxy-m-tolyl) propionate)) from BASF, Sumilizer® GP (2-tert-butyl-6-methyl-4-[3-(2,4,8, 10-tetratert-butylbenzo[d] [1,3,2] benzodioxaphosphepin-6-yl)oxypropyl]phenol; cas: 203255-81-6), Sumilizer® GA 80 (3,9-Bis[2-[3-(3-tert-butyl-4-hydroxy-5-methylphenyl) propionyloxy]-1,1-dimethylethyl]-2, 4, 8, 10-tetraoxaspiro[5.5]undecane, cas: 90498-90-1), Sumilizer® GS (2-Propenoic acid, 2-[1-[3,5-bis(1,1-dimethylpropyl)-2-hydroxyphenyl]ethyl]-4,6-bis(1,1-dimethylpropyl)phenyl ester, cas: 123968-25-2), and Sumilizer® GM (2-tert-butyl-6-(3-tert-butyl-2-hydroxy-5-methylbenzyl)-4-methylphenyl acrylate, cas: 61167-58-6) from Sumitomo, and Cyanox® 1790 (1,3,5-Tris(4-(tert-butyl)-3-hydroxy-2,6-dimethylbenzyl)-1,3,5-triazinane-2,4,6-trione, cas: 40601-76-1) from Solvay. Thiosynergist includes thioether and thioester which are also known in the art.

### Surfactant(s)

Surfactant(s) are part of the suspoemulsion to prevent creaming, coagulation or sedimentation or any other phase separation during storage.

Types of suitable surfactant are not particularly limited in present disclosure. Surfactant of present disclosure can be nonionic surfactant or ionic surfactant. Ionic surfactant includes anionic surfactant, cationic surfactant, and combinations thereof. Skilled artisan may choose one or more suitable surfactant(s) per specific application.

In present disclosure, preference is given to nonionic surfactant, anionic surfactant, or combination thereof.

Examples of suitable surfactants include alcohol ethoxylates, amine ethoxylates, Phenol ethoxylates, alkyl polyglucosides, fatty alcohol alkoxylate, fatty alcohol polyglycol ether, amine alkoxylate, guerbert alcohol alkoxylate, amine polyols, polyethylene glycols, methyl polyethylene glycols, alkyl polyethylene glycol copolymers, alkyl polypropylene glycols, polyethylene oxide homopolymers/copolymers, polypropylene oxide homopolymers/copolymers, polyfuntional polyalkylene glycols, fatty alcohol sulfates, fatty alcohol ether sulfates, linear alkylbenzene sulfonates, oleic acid sulfonates, stearic acid sulfonates, oleates, stearates.

These surfactants are available commercially or can be prepared according to known methods.

In some preferable embodiments, examples of suitable surfactants include methacrylic acid-methyl methacrylate-polyethylene glycol graft copolymers, tristyrylphenol ethoxylates, sulfated or phosphated tristylphenol ethoxylates and salts thereof, propylene oxide-ethylene oxide block copolymers, fully/partially saponified polyvinyl alcohols, alcohol ethoxylates, fatty alcohol sulfates, fatty alcohol ether sulfates, linear alkylbenzene sulfonates, oleic acid sulfonates, oleates and stearates.

In some preferable embodiments, the first surfactant and the second surfactant is the same surfactant. By using same surfactant for both suspension and emulsion, it is easy for operation and makes the aqueous antioxidant suspoemulsion being more stable.

The amount of surfactant is not particularly limited. For example, in some embodiments, the first surfactant together with the second surfactant is present in an amount from 1 wt % to 10 wt %, based on total weight of the aqueous antioxidant suspoemulsion. When the amount of the first surfactant together with the second surfactant is equal to or bigger than 1 wt %, the aqueous antioxidant suspoemulsion has better stability. Preferably, the first surfactant together with the second surfactant is present in an amount from 1 wt % to 10 wt %, preferably from 3 wt % to 8 wt %, based on total weight of the aqueous antioxidant suspoemulsion.

In addition to the aforementioned components, the aqueous antioxidant suspoemulsion of present disclosure may further comprise one or more additives that are commonly used in the art. Examples of suitable additives includes as a thickener, an anti-freeze agent, anti-foaming agent, a rheology modifier, a preservative, and a colorant.

Examples of thickener, anti-freeze agent, anti-foaming agent, rheology modifier, emulsifier, dispersant, preservative, colorant, and an inert filler suitable for present disclosure are those commonly used in the art. Skilled one in the art may select appropriate additives per specific application.

In some embodiments, the aqueous antioxidant suspoemulsion of present disclosure may further comprises light stabilizer, for example, UV absorbers (like dimethyl keton benzene type, oxanilide type, benzotriazole type, triazine type), and hindered amine light stabilizers (HALS). With addition of light stabilizer, the aqueous antioxidant suspoemulsion of present disclosure can further protect polymers against photoaging.

In present aqueous antioxidant suspoemulsion, the continuous phase is water and no organic solvent is used. Therefore, present aqueous antioxidant suspoemulsion is free of organic solvent, which in one hand is more economic viable and in the other hand it avoids wastewater problem caused by using organic solvent.

### II. Process for Preparing the Aqueous Antioxidant Suspoemulsion

In a second aspect, present disclosure provides a process for preparing the aqueous antioxidant suspoemulsion.

The aqueous antioxidant suspoemulsion according to present disclosure can be prepared by below methods. For example, the aqueous antioxidant suspoemulsion is prepared according to below steps:
Step 1. Preparing a suspension of a solid antioxidant by mixing at least one solid antioxidant having a melting point of above 20° C., a first surfactant with water;
Step 2. Preparing an oil-in-water emulsion of a second antioxidant by mixing at least one liquid antioxidant having a melting point of below 20° C., a second surfactant with water; and
Step 3. Preparing an aqueous antioxidant suspoemulsion by adding the oil-in-water emulsion prepared in step 2 into the suspension prepared in step 1 under continuous agitation;
Homogenizing the solid antioxidant and the liquid antioxidant until median particle size D50 of solid antioxidant and liquid antioxidant being below 10 μm, preferably below 5 μm, more preferably below 2 μm is achieved.

In some other alternative embodiments, the aqueous antioxidant suspoemulsion can be prepared according to below steps:
Step 1. Preparing a suspension of a solid antioxidant by mixing at least one solid antioxidant having a melting point of above 20° C., a first surfactant with water;
Step 2. Preparing a self emulsifiable concentrate of a liquid antioxidant by mixing at least one liquid antioxidant having a melting point of below 20° C. with a second surfactant; and
Step 3. Preparing an aqueous antioxidant suspoemulsion by adding the self emulsifiable concentrate prepared in step 2 into the suspension prepared in step 1 under continuous agitation;
Homogenizing the solid antioxidant and the liquid antioxidant until median particle size D50 of solid antioxidant and liquid antioxidant being below 10 μm, preferably below 5 μm, more preferably below 2 μm is achieved.

In some preferable embodiments, homogenization of the solid antioxidant and liquid antioxidant in above processes can be performed by bead milling and/or under high shear.

In some preferable embodiments, solid antioxidant is homogenized by milling in step 1, and/or self emulsifiable concentrate of liquid antioxidant/oil-in-water emulsion of liquid antioxidant is homogenized under high shear in step 2.

According to present process, a new antioxidant dispersion system, i.e. aqueous antioxidant suspoemulsion prepared from solid antioxidant and liquid antioxidant, is provided which is suitable for stabilizing polymeric materials synthesized by suspension/micro-suspension/emulsion polymerization and greatly broadens the scope of suitable antioxidant blends.

Further, as discussed in the background part, in order to prepare aqueous form antioxidant with solid antioxidant and liquid antioxidant, the solid antioxidant need to be melted firstly and most preparation steps shall be conducted at high temperature (i.e. above melting point of solid antioxidant) according to prior art. In contrast, solid antioxidant does not need to be melted according to present process. It has now been found by present inventors that a stable aqueous antioxidant suspoemulsion can be obtained when particle size of the solid/liquid antioxidant is reduced to below 10 μm, which can be achieved by homogenization (e.g. by homogenizer). Therefore, present process does not require melting (high temperature) treatment of the solid antioxidants which makes present process being simpler and more cost effective. Besides, antioxidant performance of the solid antioxidant is better preserved without undergoing high temperature treatment.

According to present disclosure, suspension/self emulsifiable concentrate/oil-in-water emulsion/aqueous antioxidant suspoemulsion can be made homogeneous by conventional mixing methods, such as those methods known for preparing emulsions in the prior art. Mixing and agitation can be carried out by conventional dispersing equipment, for example, by vortex mixer, homogenizer, conventional stirring machines with a paddle blade and etc. In order to achieve the desired median particle size D50 of the antioxidants, homogenizing of solid antioxidant and liquid antioxidant is carried out with equipment like homogenizer (e.g. bead/ball mill, blade, rotor-stator dispersing homogenizer and etc.).

In some preferable embodiments, the solid antioxidants are homogenized by milling in step 1 until median particle size D50 of solid antioxidant being below 10 μm, preferably below 5 μm, more preferably below 2 μm is achieved. As mentioned in above text, most steps for preparing aqueous antioxidant suspoemulsion with solid antioxidant and liquid antioxidant according to prior art are conducted at a temperature higher than melting point of the solid antioxidant. Accordingly, melting point of suitable solid antioxidants shall not be higher than 95° C. because the maximum operational temperature of common homogenizer can only be set at around 95° C. By homogenizing the solid antioxidant by milling (e.g. by bead/ball mills) according to present disclosure, there is no need to process the solid antioxidant at high temperature. The desired median particle size D50 of present disclosure can be achieved by milling. Therefore, suitable solid antioxidant of present disclosure is not subject to melting point and present disclosure has no limitation on upper melting point of the solid antioxidant which further broadens the scope of suitable solid antioxidant, compared to the current state of the art.

In some preferable embodiments, the liquid antioxidants are homogenized under high shear in step 2 (e.g. by blade type homogenizer) until median particle size D50 of the liquid antioxidant being below 10 μm, preferably below 5 μm, more preferably below 2 μm is achieved.

Examples of solid antioxidants, liquid antioxidants, and surfactants suitable for present process are the same as those described in the first aspect (I. Aqueous antioxidant suspoemulsion) of present disclosure.

In some embodiments, the process further includes adding at least one additive selected from the group consisting of a thickener, an anti-freeze agent, anti-foaming agent, a rheology modifier, a preservative, a colorant, and an inert filler. Examples of additives suitable for present process are the same as those described in the first aspect. And these additives can be added in any steps in the process for preparing aqueous antioxidant suspoemulsion as described above.

### III. The Aqueous Antioxidant Suspoemulsion Produced According to Present Disclosure

In a third aspect, present disclosure provides an aqueous antioxidant suspoemulsion produced according to the process described in the second aspect (II. Process for preparing the aqueous antioxidant suspoemulsion) of present disclosure.

Advantages of the aqueous antioxidant suspoemulsion prepared according to the process as described in the second aspect have been given in above.

### IV. Use of the Aqueous Antioxidant Suspoemulsion

In view of benefits of above aqueous antioxidant suspoemulsion, in a fourth aspect, present disclosure provides use of above aqueous antioxidant suspoemulsion in stabilizing polymeric materials, like rubber, plastics, resin and etc. materials. Present aqueous antioxidant Suspoemulsion protects substrates against thermal/oxygen/light degradation of polymers during manufacturing, processing and end use.

Particularly, aqueous antioxidant suspoemulsion of present disclosure is useful in suspension polymerization process, emulsion polymerization process or micro-suspension polymerization process.

### V. Polymer Composition

As discussed above, the aqueous antioxidant suspoemulsion of present disclosure can be used in a suspension polymerization process, emulsion polymerization process, or micro-suspension polymerization process, for stabilizing polymeric materials, like rubber, plastics, resin and etc.

Therefore, in a fifth aspect, present disclosure provides a polymer composition, comprising
a polymer in a form of aqueous suspension or emulsion; and
an aqueous antioxidant suspoemulsion according to present disclosure or prepared according to the process of present disclosure.

The term “polymer”, as used herein, includes both homopolymer(s) and copolymer(s). The polymer can be prepared by conventional methods, such as suspension polymerization, emulsion polymerization, or micro-suspension polymerization. The aqueous antioxidant suspoemulsion is particularly suitable for stabilizing polymer latex, e.g. ABS latex. The term “polymer latex” is a stable dispersion of polymer microparticles in an aqueous medium.

Examples of applicable polymers include rubber, plastic, resin. Specific examples include polyvinyl chloride (PVC), acrylonitrile butadiene styrene (ABS), methyl methacrylate butadiene styrene (MBS), and etc.

The blending ratio of aqueous antioxidant suspoemulsion and polymer has no particular limitation, and it can be appropriately selected from a wide range.

The polymer composition may include other additives, like a thickener, an anti-freeze agent, anti-foaming agent, a rheology modifier, a preservative, a colorant, an inert filler, and etc., These additives can be added during the preparation of the aqueous antioxidant suspoemulsion and/or during the polymerization of polymers.

The aqueous antioxidant suspoemulsion can be easily added or dosed into the polymerization system during polymerization or polymer compounding by conventional methods, such as by pressurization. Because the aqueous antioxidant suspoemulsion of present disclosure can be uniformly dispersed in the reaction mixture, the resulting polymers has excellent stability from manufacturing to end use.

Present disclosure is further illustrated by the following examples.

### EXAMPLES

Materials

| Description | Abbreviation | Chemical name | Source |
|---|---|---|---|
| Antioxidant | IX 3114 | 1,3,5-tris(3,5-di-tert-butyl-4- | Irganox ® 3114 from |
| | | hydroxybenzyl)-1,3,5-triazine- | BASF |
| | | 2,4,6(1H,3H,5H) trione | |
| | IX 1010 | pentaerythritol tetrakis[β-(3,5,-di- | Irganox ® 1010 from |
| | | tert-butyl-4- | BASF |
| | | hydroxyphenyl)propionate] | |
| | IX 1076 | octadecyl 3-(3,5-di-tert-butyl-4- | Irganox ® 1076 from |
| | | hydroxyphenyl) propionate | BASF |
| | IX 245 | ethylenebis(oxyethylene)bis[3-(5- | Irganox ® 245 from |
| | | tert-butyl-4-hydroxy-m- | BASF |
| | | tolyl)propionate] | |
| | IX 1330 | 3,3′,3′,5,5′,5′-hexa-tert-butyl- | Irganox ® 1330 from |
| | | a,a′,a′-(mesitylene-2,4,6-triyl) tri- | BASF |
| | | p-cresol | |
| | IX 565 | 2,6-di-tert-butyl-4-(4,6- | Irganox ® 565 from |
| | | bis(octylthio)-1,3,5-triazin-2- | BASF |
| | | ylamino) phenol | |
| | WSL | Phenol, 4-methyl-, reaction | Wingstay ® L from |
| | | products with dicyclopentadiene | Synthomer |
| | | and isobutylene | |
| | IX 802 | 3,3′-Thiodipropionic acid | Irganox ® PS 802 |
| | | dioctadecylester | from BASF |
| | DTDTDP | ditridecyl 3,3′-thiodipropionate | NAUGARD ® DTDTDP |
| | | | from SIG/Addivant |
| | IX 1520 | 4,6-bis(octylthiomethyl)-o-cresol | Irganox ® 1520 from |
| | | | BASF |
| | IX 5057 | Benzenamine, N-phenyl-, | Irganox ® 5057 from |
| | | reaction products with 2,4,4- | BASF |
| | | trimethylpentene | |
| | IX 1135 | Benzenepropanoic acid, 3,5-bis | Irganox ® 1135 from |
| | | (1,1-dimethyl-ethyl)-4-hydroxy- | BASF |
| | | C7-C9 branched alkyl esters | |
| Surfactant | PVA | Polyvinyl alcohol | Inovol PA8 from |
| | | | Ineos |
| Anti-foam | Rhodorsil | Dialkylpolisiloxan | Rhodorsil ® antiofoam |
| agent | antifoam | | 416 |
| | 416 | | from Rhodia |

### Test Methods

Particle size of solid antioxidants and droplet size of liquid antioxidants in the aqueous antioxidant suspoemulsion is measured with Malvern Mastersizer 2000 spectrometer and recorded as median particle size (D50) in microns by diluting 1.0 ml sample in 40 ml of deionized water.

Solid content of the aqueous antioxidant suspoemulsion was measured per following procedure:

A crystallization dish is dried in a preheated drying oven for 1 hour at 105° C. and subsequently allow to cool in a desiccator for approximate 30 minutes. Weight of the dish is recorded as W1. Sample (˜3 g) is weighted (recorded as W2) with precision into the dried crystallization dish and dried at 105° C. for at least for 2 hours (till constant weight is achieved, recorded as W3).

The solid content is calculated from the following equation:

$$SC = ( W 3 - W 1 ) / W 2 \times 100$$

pH is measured using a Metrohm 744 PH Meter at room temperature.

### Inventive Examples for Preparing Aqueous Antioxidant Suspoemulsion

The aqueous antioxidant suspoemulsion according to present disclosure is prepared according to below steps.

### Step 1. Prepare Aqueous Suspension of Solid Antioxidant:

At room temperature (˜20° C.), mix 200 g solid antioxidants as shown in below table, 20 g polyvinyl alcohol (PVA), 279 g deionized water and 1.0 g Rhodorsil antifoam 416; then agitate the mixture with an ultra turrax.

The resulting aqueous suspension is then fine milled in a horizontal agitating bead mill (Dyno-Mill model) till D50 particle size of the solid antioxidant shown in below table is reached.

| Suspension | Solid | | | | Solid content | D50 |
|---|---|---|---|---|---|---|
| No. | Antioxidant | Melting point | | PVA | [%] | [μm] |
| 1 | IX 1010 | 110-125° | C. | 4% | 43.6 | 1.3 |
| 2 | IX 1076 | 50-55° | C. | 4% | 44.1 | 1.4 |
| 3 | IX 245 | 76-79° | C. | 4% | 43.0 | 1.6 |
| 4 | IX 1330 | 240-245° | C. | 4% | 43.5 | 1.1 |
| 5 | IX 565 | 91-96° | C. | 4% | 43.4 | 1.3 |
| 6 | WSL | 115° | C. | 4% | 43.1 | 1.8 |
| 7 | IX 802 | 64-67° | C. | 4% | 42.9 | 0.9 |

### Step 2. Prepare Oil-In-Water Emulsion

At room temperature (˜20° C.), dissolve 4 g PVA into 46 g deionized water by agitation, then dissolve 50 g liquid antioxidant as shown in below table into water containing the dissolved PVA and agitate the mixture at 10,000 rpm for 3-5 minutes by Homogenizer (T18, IKA) to reach the value of median particle size D50 of the liquid antioxidant shown in below table.

Oil-in-water

| Emulsion | Liquid | | | | Solid content | D50 |
|---|---|---|---|---|---|---|
| No. | Antioxidant | Melting point | | PVA | [%] | [μm] |
| A | DTDTDP | −24° | C. | 4% | 50.1% | 1.4 |
| B | IX 1520 | 12-15° | C. | 4% | 48.8% | 1.2 |
| C | IX 5057 | —* | | 4% | 49.3% | 1.6 |
| D | IX 1135 | <−30° | C. | 4% | 49.8% | 1.4 |

IX 5057 is liquid at 20° C.

### Step 3. Prepare Aqueous Antioxidant Suspoemulsion

At room temperature, add the oil-in-water emulsion prepared according to step 2 into the aqueous suspension prepared according to step 1, then agitate the mixture at 300 rpm for 5 minutes by agitator to achieve a homogeneous system.

| Inventive | Aqueous | Oil- in-water | Ratio suspension/ | Solid |
|---|---|---|---|---|
| Examples No. | suspension | emulsion | emulsion (vol/vol) | content |
| 1B | IX 1010 | IX 1520 | 55/45 | 54.1% |
| 1C | IX 1010 | IX 5057 | 55/45 | 55.0% |
| 2B | IX 1076 | IX 1520 | 55/45 | 54.0% |
| 3B | IX 245 | IX 1520 | 55/45 | 53.4% |
| 4B | IX 1330 | IX 1520 | 55/45 | 54.6% |
| 5B | IX 565 | IX 1520 | 55/45 | 54.5% |
| 6A | WSL | DTDTDP | 55/45 | 53.6% |
| 7B | IX 802 | IX 1520 | 55/45 | 54.0% |
| 7D | IX 802 | IX 1135 | 55/45 | 53.6% |

Alternatively, the aqueous antioxidant suspoemulsion of present disclosure can be prepared according to below steps.

Step 1. The aqueous suspension of solid antioxidant is prepared in the same way as described in step 1 of above Inventive Example I.

### Step 2. Preparation of a Self Emulsifiable Concentrate

Dissolve 4 g PVA into 46 g liquid antioxidant as shown in below table under continuous agitation (at 500 rpm) till a homogenous solution is achieved.

Self emulsifiable

| concentrate | Liquid | | | | Solid content |
|---|---|---|---|---|---|
| Examples No. | Antioxidant | Melting point | | PVA | [%] |
| E | IX 1520 | 12-15° | C. | 4% | 49.9% |
| F | IX 1135 | <−30° | C. | 4% | 50.1% |

### Step 3. Prepare Aqueous Antioxidant Suspoemulsion

At room temperature, add the self emulsifiable concentrate prepared according to step 2 into the aqueous suspension prepared according to step 1, then agitate the mixture at 1000 rpm for 5 minutes by agitator to achieve a homogenized system.

| | | Self | Ratio | |
|---|---|---|---|---|
| Inventive | Aqueous | emulsifiable | suspension/ | Solid |
| Examples No. | suspension | concentrate | emulsion (vol/vol) | content |
| 1E | IX 1010 | IX 1520 | 70/30 | 53.6% |
| 7F | IX 802 | IX 1135 | 70/30 | 53.8% |

### Stability Test

Physical stability testing is performed on samples of 7B, 1B, 3B, 1C and 7D prepared according to above inventive examples at 50° C. for 14 days so as to predict their storage stability. A formulation is considered stable when its median particle size (D50) change is below 10% and no creaming or sedimentation is observed.

| | | | | | Stability |
|---|---|---|---|---|---|
| | | | pH | | verdict |
| Example | PSD (D10, D50, D90) [μm] | | | 50° C.; | (50° C.; |
| No. | Initial | 50° C. (14 d) | (initial) | 14 d) | 14 d) |
| 7B | 0.890, 1.554, 2.973 | 0.826, 1.702, 7.404 | 5.7 | 7.0 | excellent |
| 1B | 0.671, 1.320, 2.277 | 0.821, 1.384, 2.337 | 5.6 | 6.9 | excellent |
| 3B | 0.953, 1.637, 2.894 | 0.873, 1.653, 3.351 | 5.7 | 6.5 | excellent |
| 1C | 0.657, 1.303, 2.614 | 0.714, 1.236, 2.127 | 5.1 | 5.7 | excellent |
| 7D | 0.578, 1.276, 2.484 | 0.614, 1.365, 2.422 | 5.8 | 6.7 | excellent |

Results of above table show that all of these inventive samples have a D50 of below 2 μm after storing at 50° C. for 14 days as well as D50 change being below 10%. Neither creaming nor sedimentation is observed. The aqueous antioxidant suspoemulsion of present disclosure provides excellent stability. Besides, pH change of these samples is smaller than 25% which is good for maintaining antioxidant performance of the samples as pH change has an influence on antioxidant performance.

### Abs OIT Test

### Material: ABS Latex

ABS latex has a solid content of 46% and Particle Size Distribution (PSD): D50 of 0.3 μm.

### ABS Stabilization and Coagulation:

Mix 218 g of the ABS latex with 0.94 g of the aqueous antioxidant suspoemulsion prepared according to inventive examples. Then, mix 1.55 g of sulfuric acid (c: 98%) with 171 g of deionized water at 65° C.

At temperature of around 65° C., add the stabilized ABS latex into the diluted solution of sulfuric acid under continuous agitation to trigger coagulation of the ABS substrates.

Then increase the temperature to 93° C. and keep this temperature for additional 3 minutes.

Then cool down the slurry to room temperature. Filter and wash the slurry 3 times with deionized water. Dry the filtrate at 60° C. for 20 hours to obtain dried and stabilized ABS.

### OIT Measurement

Oxidation induction peak time (OIT Peak time) measures the level of thermal stabilization of the material tested.

OIT Peak time of above ABS samples is measured as below. In specific, the coagulated and dried stabilized ABS sample is put in a differential scanning calorimetry (DSC) device and the sample is heated to 198° C. under nitrogen atmosphere. When 198° C. is reached, the sample is maintained at isothermal condition for 5 minutes, and the gas is changed from nitrogen to oxygen. The flow rate of the oxygen is maintained at 50 ml/min.

Under these conditions the antioxidants are consumed over time. At a point, the ABS sample starts degradation or oxidization, and thereby liberate additional heat (exotherm reaction). The time it takes for this exotherm reaction to reach peak from the time that the oxygen is introduced is reported as the OIT Peak time. The longer the OIT Peak time, the better the thermal stability of ABS.

| Comparative | | | Dispersion | OIT Peak time |
|---|---|---|---|---|
| Examples No. | Antioxidant components | | type | [min] |
| A | — | DTDTDP | E | 6 |
| B | — | IX 1520 | E | 10 |
| C | — | IX 5057 | E | 28 |
| D | — | IX 1135 | E | 23 |
| 1 | IX 1010 | — | S | 14 |
| 2 | IX 1076 | — | S | 25 |
| 3 | IX 245 | — | S | 37 |
| 4 | IX 1330 | — | S | 41 |
| 5 | IX 565 | — | S | 47 |
| 6 | WSL | — | S | 54 |
| 7 | IX 802 | — | S | 4 |

E: emulsion;
S: suspension;
SE: suspoemulsion

| Inventive | | | | |
|---|---|---|---|---|
| Examples | | | Dispersion | OIT Peak time |
| No. | Antioxidant components | | type | [min] |
| 1B | IX 1010 | IX1520 | SE | 35 |
| 1C | IX 1010 | IX 5057 | SE | 33 |
| 2B | IX 1076 | IX1520 | SE | 32 |
| 3B | IX 245 | IX1520 | SE | 59 |
| 4B | IX 1330 | IX1520 | SE | 51 |
| 5B | IX 565 | IX1520 | SE | 50 |
| 6A | WSL | DTDTDP | SE | 53 |
| 7D | IX 802 | IX 1135 | SE | 30 |
| 7B | IX 802 | IX1520 | SE | 45 |
| 1E | IX 1010 | IX 1520 | SE | 28 |
| 7F | IX 802 | IX 1135 | SE | 24 |

E: emulsion;
S: suspension;
SE: suspoemulsion

Compared to comparative examples (single suspension antioxidant or emulsion antioxidant), the OIT Peak time of most ABS latex processed with the aqueous antioxidant suspoemulsion of present disclosure is significantly improved. Accordingly, thermal stabilization effect of these aqueous antioxidant is superior to single suspension or emulsion system. Aqueous antioxidant suspoemulsion of present disclosure shows strong synergistic effect in terms of thermal stabilization as indicated by the significantly increased OIT Peak time. In specific, inventive examples of 1B, 1C, 2B, 3B, 4B, 5B, 7D, 7B, 1E and 7F show absolute synergism as their OIT Peak time is longer than each single suspension or emulsion systems.

In present inventive example 6A, WSL is combined with DTDTDP (in a ratio of 55:45) to prepare the aqueous antioxidant Suspoemulsion. Inventive example 6 A shows relative synergism as its OIT Peak time (53 mins) is much higher than 32.4 mins that is mathematically expected (54 mins (Comparative example 6)*55%+6 mins (comparative example A)*45%=32.4 mins).

Further, present inventive example 6A has good OIT Peak time yet amount of WSL is half reduced which is particularly advantageous from healthy point of view, as shown in above table.

Although the embodiments and examples of the present disclosure are described above, skilled person in the art should understand that they are only for illustrative purpose, and are not intended to limit the protection scope of the present disclosure. The protection scope of the present disclosure is defined by the appended claims. Skilled person in the art can make various modifications, equivalent substitutions or improvements to these embodiments without departing from the scope and spirit of the present disclosure, but these modifications, equivalent substitutions or improvements fall within the protection scope of the present disclosure.

1.-23. (canceled)

24. An aqueous antioxidant suspoemulsion, wherein the aqueous antioxidant suspoemulsion comprises:
(i) a continuous water phase of component (C1), comprising:
(a) at least one solid antioxidant having a melting point of above 20° C.,
(b) a first surfactant; and
(c) water having the solid antioxidant suspended therein; and
(ii) a dispersed oil phase of component (C2), comprising:
(d) at least one liquid antioxidant having a melting point less than 20° C., and
(e) a second surfactant having the liquid antioxidant dispersed in the water;
wherein the solid antioxidant comprises particles with a median particle size D50 less than 10 μm, and the liquid antioxidant comprises droplets with a median particle size D50 less than 10 μm.

25. The aqueous antioxidant suspoemulsion according to claim 24, wherein the solid antioxidant together with the liquid antioxidant is present in an amount of at least 20 wt %, based on total weight of the aqueous antioxidant suspoemulsion.

26. The aqueous antioxidant suspoemulsion according to claim 24, wherein the weight ratio of the solid antioxidant to the liquid antioxidant is from 1:50 to 50:1.

27. The aqueous antioxidant suspoemulsion according to claim 24, wherein the liquid antioxidant comprises droplets with a median particle size D50 less than 5 μm.

28. The aqueous antioxidant suspoemulsion according to claim 24, wherein the solid antioxidant comprises particles with a median particle size D50 less than 5 μm.

29. The aqueous antioxidant suspoemulsion according to claim 24, further comprising an amount of the first surfactant and the second surfactant from 1 wt % to 10 wt %, based on total weight of the aqueous antioxidant suspoemulsion.

30. The aqueous antioxidant suspoemulsion according to claim 29, wherein each of the first surfactant and the second surfactant are selected from the group consisting of nonionic surfactant, anionic surfactant, and combinations thereof.

31. The aqueous antioxidant suspoemulsion according to claim 24, wherein at least one of the first surfactant and the second surfactant is selected from the group consisting of methacrylic acid-methyl methacrylate-polyethylene glycol graft copolymers, tristyrylphenol ethoxylates, sulfated or phosphated tristylphenol ethoxylates and salts thereof, propylene oxide-ethylene oxide block copolymers, fully/partially saponified polyvinyl alcohols, alcohol ethoxylates, fatty alcohol sulfates, fatty alcohol ether sulfates, linear alkylbenzene sulfonates, oleic acid sulfonates, oleates and stearates.

32. The aqueous antioxidant suspoemulsion according to claim 24, wherein the first surfactant and the second surfactant are the same surfactant.

33. The aqueous antioxidant suspoemulsion according to claim 24, wherein the solid antioxidant is selected from the group consisting of octadecyl 3-(3,5-di-tert-butyl-4-hydroxyphenyl) propionate; 3,3′-Thiodipropionic acid dioctadecylester; pentaerythritol tetrakis[β-(3,5,-di-tert-butyl-4-hydroxyphenyl) propionate]; 2,6-di-tert-butyl-4-(4,6-bis(octylthio)-1,3,5-triazin-2-ylamino) phenol; 3,3′,3′,5,5′,5′-hexa-tert-butyl-a, a′,a′-(mesitylene-2,4,6-triyl) tri-p-cresol; Phenol, 4-methyl-, reaction products with dicyclopentadiene and isobutylene; ethylenebis(oxyethylene)bis[3-(5-tert-butyl-4-hydroxy-m-tolyl) propionate]; Thiodiethylene bis[3-(3,5-di-tert-butyl-4-hydroxyphenyl) propionate]; N,N′-hexane-1,6-diylbis(3-3,5-di-tert-butyl-4-hydroxyphenylpropionamide); N,N′-Bis(3,5-di-butyl-4-hydroxyle-phenyl propionyl) hydrazine; 1,3,5-tris[(4-tert-butyl-3-hydroxy-2,6-dimethylphenyl)methyl]-1,3,5-triazinane-2,4,6-trione; 2,2′-Methylenebis(4-methyl-6-tert-butylphenol); Hexamethylene bis[3-(3,5-di-tert-butyl-4-hydroxyphenyl) propionate]; 1,3,5-tris(3,5-di-tert-butyl-4-hydroxybenzyl)-1,3,5-triazine-2,4,6 (1H,3H,5H)trione; Butylated hydroxytoluene; 2-(1,1-dimethylethyl)-6-[[3-(1,1-dimethylethyl)-2-hydroxy-5-methylphenylymethyl-4-methylphenyl acrylate; 2,2-Bis[[3-(dodecylthio)-1-oxopropoxy]methyl]propane-1,3-diyl bis[3-(dodecylthio) propionate]; 2,4-Bis(dodecylthiomethyl)-6-methylphenol; Didodecyl-3,3′-thiodipropionate; and combinations thereof.

34. The aqueous antioxidant suspoemulsion according to claim 24, wherein the liquid antioxidant is selected from the group consisting of 4,6-bis(octylthiomethyl)-o-cresol; 2,4-dimethyl-6-(1-methyl pentadecyl) phenol; benzenepropanoic acid, 3,5-bis(1,1-dimethyl-ethyl)-4-hydroxy-C7-C9 branched alkyl esters; benzenamine, N-phenyl-, reaction products with 2,4,4-trimethylpentene; ditridecyl 3,3′-thiodipropionate; benzenepropanoic acid, 3,5-bis(1,1-dimethylethyl)-4-hydroxy-, C13-15-branched and linear alkyl esters; and combinations thereof.

35. The aqueous antioxidant suspoemulsion according to claim 24, further comprising a half-hindered phenol antioxidant and a thiosynergist.

36. The aqueous antioxidant suspoemulsion according to claim 24, further comprising at least one additive selected from the group consisting of a thickener, an anti-freeze agent, anti-foaming agent, a rheology modifier, an emulsifier, a dispersant, a preservative, an antioxidant, a colorant, and an inert filler.

37. The aqueous antioxidant suspoemulsion according to claim 24, further comprising a light stabilizer.

38. The aqueous antioxidant suspoemulsion according to claim 24, wherein the aqueous antioxidant suspoemulsion is free of organic solvents.

39. A process for preparing aqueous antioxidant suspoemulsion, comprising:
preparing a suspension of a solid antioxidant by mixing at least one solid antioxidant having a melting point of above 20° C. and a first surfactant with water;
preparing an oil-in-water emulsion of a liquid antioxidant by mixing at least one liquid antioxidant having a melting point less than 20° C. and a second surfactant with water; and
preparing an aqueous antioxidant suspoemulsion by adding the oil-in-water emulsion of the liquid antioxidant into the suspension of the solid antioxidant under continuous agitation; and
homogenizing the solid antioxidant and the liquid antioxidant until a median particle size D50 of the solid antioxidant and the liquid antioxidant is less than 10 μm.

40. A process for preparing aqueous antioxidant suspoemulsion, comprising:
preparing a suspension of a solid antioxidant by mixing at least one solid antioxidant having a melting point of above 20° C. and a first surfactant with water;
preparing a self emulsifiable concentrate of a liquid antioxidant by mixing at least one liquid antioxidant having a melting point less than 20° C. with a second surfactant; and
preparing an aqueous antioxidant suspoemulsion by adding the self emulsifiable concentrate into the suspension of the solid antioxidant under continuous agitation;
homogenizing the solid antioxidant and the liquid antioxidant until the median particle size D50 of the solid antioxidant and the liquid antioxidant is less than 10 μm.

41. The process for preparing aqueous antioxidant suspoemulsion according to claim 39,
wherein the solid antioxidant and the liquid antioxidant are homogenized until the median particle size D50 of the solid antioxidant and the liquid antioxidant is less than 5 μm.

42. The process for preparing aqueous antioxidant suspoemulsion according to claim 39,
wherein the solid antioxidant is homogenized by milling.

43. The process for preparing aqueous antioxidant suspoemulsion according to claim 39,
wherein the liquid antioxidant is homogenized under high shear.

44. An aqueous antioxidant suspoemulsion prepared according to the process of claim 39.

45. Use of the aqueous antioxidant suspoemulsion according to claim 24 in stabilizing polymeric materials.

46. A polymer composition, comprising:
a polymer or copolymer in a form of aqueous suspension or emulsion; and
an aqueous antioxidant suspoemulsion according to claim 24.
